(19) United States
(12) Patent Application Publication
(10) Pub. No.: US 2015/0381937 A1
(43) Pub. Date: Dec. 31, 2015

(54) FRAMEWORK FOR AUTOMATING MULTIMEDIA NARRATIVE PRESENTATIONS

(71) Applicant: Abraham Sasmito ADIBOWO, Singapore (SG)

(72) Inventor: Abraham Sasmito ADIBOWO, Singapore (SG)

(21) Appl. No.: 14/316,826

(22) Filed: Jun. 27, 2014

(51) Int. Cl. H04N 7/15; G06T 13/40

(52) U.S. Cl. CPC H04N 7/157; G06T 13/40

(57) ABSTRACT

Disclosed herein are technologies for implementing an automated multimedia narrative—presentation to one or more users. In some implementations, the user selects and views an annual presentation report from a presented listing of digital multimedia narratives. Contents of the annual presentation report may be derived from stored information in the database and the derived contents are subsequently mapped to a humanlike—animation for delivery to the one or more users.

### TECHNICAL FIELD

The present disclosure relates generally to a framework for implementing an automated multimedia narrative—presentation to one or more users.

### BACKGROUND

An earnings call is a highly-structured activity that often requires the presence of high-valued employees such as Head of Public Relations, Chief Financial Officer (CFO), or even a Chief Executive Officer (CEO). Being a highly-structured activity may also mean that it demands less of the time and skills of these senior executives, yet it is a necessary event for many publicly-traded organizations to require the presence of the CFO, CEO, etc.

However, these senior executives spend more than half of their time during the earnings call listening to other speakers. For example, while one executive is presenting her part, another executive who is waiting to present is spending time listening as well. Prior to the earnings call, these senior executives may have to spend more time in preparing their speeches than managing the operations of the company.

As teleconferences, screen-sharing, webinars, and other tele-presence technologies become more commonly used to lessen overhead costs in convening, for example, a group of employees, the demand for these summits increases. However, the net time spent on preparing and participating in these talks or summits remain the same and will remain to be so until technology can master time dilation effectively. Particularly, this yields a problem in conferences when the speaker's time is asymmetrically more valuable than the average value of the listeners' time.

### SUMMARY

Disclosed herein is a framework for implementing an automated multimedia narrative—presentation to one or more users. One aspect of the present framework may include creating a computer-generated animation of a presenter and generating a report-script based on stored information in a database. The report-script is mapped into the created animation of the presenter to generate a multimedia narrative, which may be delivered to the one or more users.

In accordance with another aspect, the framework may include an animation generator configured to create a computer-generated animation of a presenter, and a script-generator configured to generate a report-script based on stored information in a database. An animation player may be configured to map the report-script into the created animation of the presenter to generate a multimedia narrative. Further, a teleconferencing orchestrator may be configured to facilitate delivery of the multimedia narrative to one or more users.

This summary is provided to introduce a selection of concepts in a simplified form that are further described below in the following detailed description. It is not intended to identify features or essential features of the claimed subject matter, nor is it intended to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary scenario as described in present implementations herein;

FIG. 2 illustrates an exemplary system that implements an automated multimedia narrative—presentation to one or more users as described in present implementations herein;

FIG. 3 illustrates an exemplary process for implementing, at least in part, the technology described herein; and

FIG. 4 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for implementing an automated multimedia narrative—presentation to one or more users. Examples of the one or more users include individuals, business or corporate entities, etc. Technologies herein may be applied to computing and mobile applications.

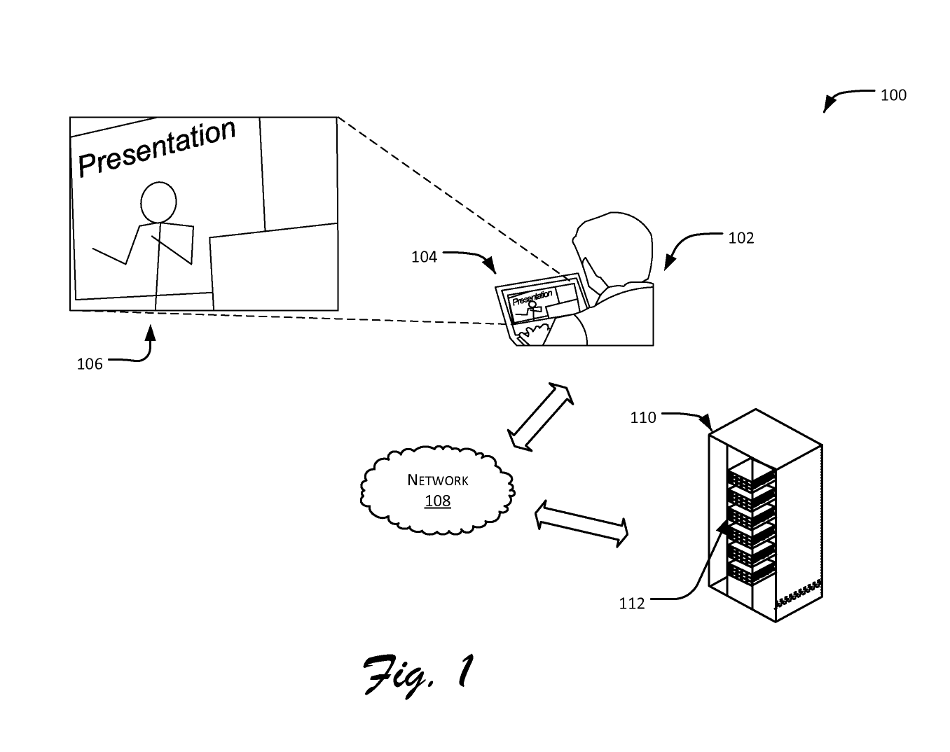

FIG. 1 illustrates an exemplary scenario 100 showing an overview of facilitating an interaction between an audience (or user) and a humanlike animation of a management executive officer (or officer) in a network environment. Scenario 100 shows an (online) user 102 holding a user-device 104, a humanlike animation officer (or officer) 106, a network 108, and a database 110 that stores digital multimedia narratives 112.

The arrangement in scenario 100 illustrates, for example, a user selection and viewing of the stored digital multimedia narratives, and communication by the user with the one or more officers associated with the selected digital multimedia narrative. The communication, for example, may take the form of a user sending questions and queries to topics of the selected digital multimedia narrative. These questions and queries may be answered by a human version or actual presenter (not shown) of the one or more officers 106 in cases, for example, where scenario 100 is a live (on-going) session.

As an example of present implementations herein, the user-device 104 includes a display screen to present a listing of digital multimedia narratives 112 to the user 102. The digital multimedia narratives 112 may include recorded videos of lectures, presentations, company annual updates, and the like, by the officer 106 on behalf of the actual presenter. In another example, the user-device 104 may assist in connecting to a live (on-going) session where there are other users with their respective user-devices 104 viewing the same presentation in real-time. Furthermore, the human version of the presenter 106 may be available in the background to answer questions that the animation (i.e., officer 106) may not have anticipated.

For example, the listing of digital multimedia narratives is obtained from the digital multimedia narratives 112 of the database 110. In another example, the listing of digital multimedia narratives 112 is derived from the user-device itself. In these examples, the listing of the digital multimedia narratives is associated with the proposed lecture topics, conference presentation topics, financial reports, meetings, and the like, of the one or more officers 106.

With the presented listing of digital multimedia narratives, the user 102 has the option of choosing one or more digital multimedia narratives. For example, the user 102 selects a particular digital multimedia narrative 112 based on its associated type of report or presentation topic. In this example, the user-device 104 may present the listing of digital multimedia narratives to the user 102 by indicating the associated type of report or presentation topic, time duration of scheduled conference, name of the officer-lecturer in the report, other users that are currently viewing the digital multimedia narrative, and the like, in the display screen.

As shown, the user 102 is viewing, for example, an annual presentation report from the officer 106. The annual presentation report is selected by the user 102 from the presented listing of digital multimedia narratives 112. In this example, contents of the annual presentation report may be derived from stored information in the database and the derived contents are subsequently mapped to the humanlike—animation (i.e., officer 106) for delivery to the one or more users 102.

Although FIG. 1 shows a limited number of officer (i.e., officer 106) and user (i.e., user 102), the network 108 may connect multitudes of officers to multiple number of users. For example, multiple user-devices 104 may connect different users 102 with different officers 106.

As an example of present implementations herein, the officer 106 is a humanlike animated version of the actual presenter-individual who may be a top executive officer, an accountant, etc. in real life. In other words, the presentation by the officer 106, as shown in FIG. 1, is computer generated. The computer-generated presentation, for example, may be based or derived from a captured and recorded animated version of the presenter-individual and from a report-script that is derived from contents of the database 110. The report-script, for example, includes a computer generated report based on company database. Furthermore, the presenter-individual may manually add inputs or revisions to the computer generated report-script as further discussed below.

Examples of the user-devices 104 may include (but are not limited to) a mobile phone, a cellular phone, a smartphone, a personal digital assistant, a netbook, a notebook computer, a multimedia playback device, a digital music player, a digital video player, a navigational device, a digital camera, and the like.

The network 108 is a generic label for remote services offered over a computer network (e.g., the Internet) that entrusts a user's data, software, and/or computation. For example, the user-devices 104 connect to the database 110 through the network 108. In this example, the network 108 facilitates wired or wireless form of communications between the user-devices 104 and the database 110.

The database 110 may include a High-Performance Analytic Appliance (HANA) database to store digital multimedia narratives 112, company database, and other information related to the implementation of the technology as described herein. The database 110 may be implemented or found, for example, at a server side (not shown) and may be connected to the user-device 104 through the network 108.

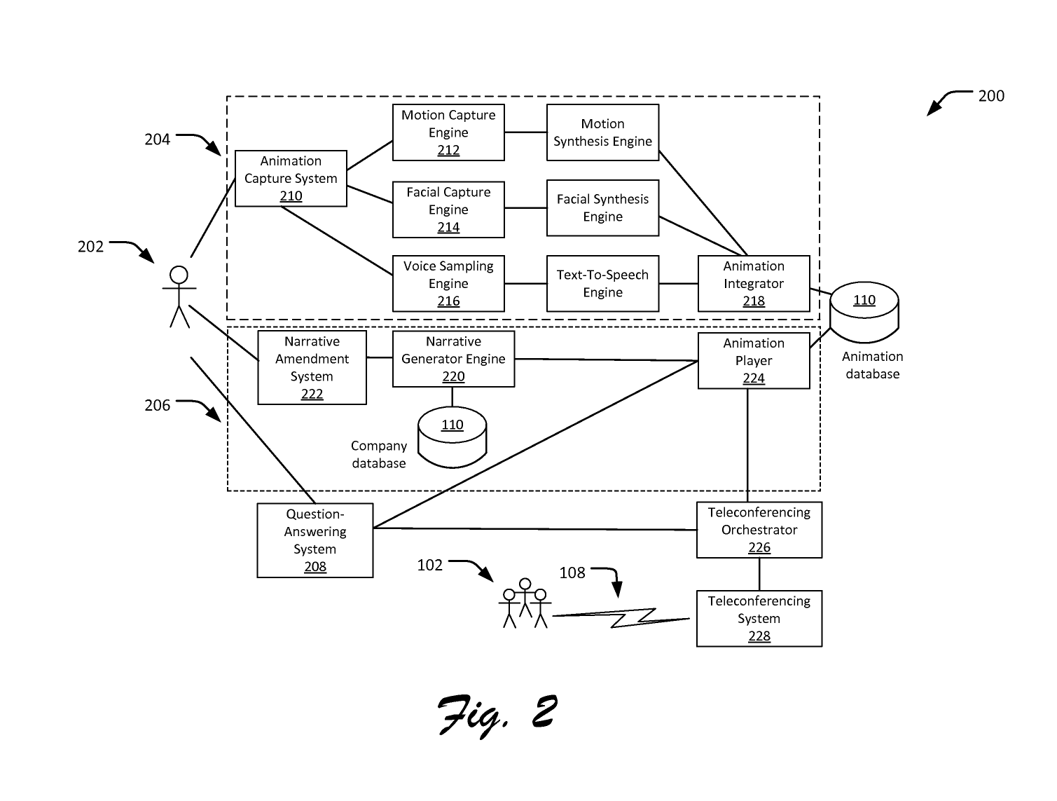

FIG. 2 is an exemplary system 200 that implements the automated multimedia narrative—presentation to the one or more users 102 in the network environment. The system 200, for example, illustrates an implementation of highly-structured stakeholder presentations between an actual presenter 202 and the one or more users 102.

As shown, the system 200 is sub-divided into three main sections i.e., an animation generator 204 that is integrated with a script-generator 206 to generate the multimedia narrative, and a question-answering system 208 that is synchronized with a delivery of the multimedia narrative to fully enhance the virtual multimedia narrative—presentation by the officer 106 (i.e., humanlike animation of presenter 202).

In an implementation, the animation generator 204 captures a humanlike animated representation of the actual presenter 202. The actual presenter 202, for example, may be a Chief Executive Officer (CEO) of a company who utilizes the implementations defined herein to save time and resources in delivering the actual presentation or report to the one or more users 102.

In capturing the humanlike animation of the presenter 202, the animation generator 204 utilizes an animation capture system 210, a motion capture engine 212, a facial capture engine 214, a voice sampling engine 216, and an animation-integrator 218 to detect, capture, synthesize, and facilitate the humanlike animated version of the actual presenter 202. In this example, the motion capture engine 212, facial capture engine 214 and the voice sampling engine 216 facilitate a computer-generated and mirror-like image of the motion and/or movements, facial expressions, and voice expressions, respectively, of the presenter 202.

In an implementation, the humanlike animation (i.e., officer 106) of the presenter 202 is stored in the database 110. In this implementation, the humanlike animation may be configured by an algorithm, for example, to perform actions and movements based on the captured motions, facial expressions, and synthesized voice of the presenter 202.

The animation generator 204 is integrated with the script-generator system 206 to map a computer-generated written report-script to the stored humanlike animation of the presenter 202.

For example, the computer-generated written report-script includes an annual-company financial report that is supposedly presented and delivered annually by the presenter 202 to the one or more users 102. In this example, the script-generator system 206 is configured to generate necessary data such as income summaries, current liabilities, debts, overhead details, and the like, that are needed or included in the annual-company financial report.

For example, a narrative generator engine 220 is configured to perform an algorithm to generate an initial narrative or report-script of the annual-company financial report based on stored data in the database 110 (i.e., company database). In this example, the initial narrative or report-script is forwarded to the presenter 202 through a narrative amendment system 222. The narrative amendment system 222, for example, may be configured to receive manual inputs, revisions, highlighting, and other information that the presenter 202 may want to add to the initial narrative or report-script. From this point, the narrative amendment system 222 may further receive final verification and approval of the report-script from the presenter 202 before forwarding the final version to an animation player 224.

In an implementation, the animation player 224 is configured to map the final version of the narrative or report-script to the stored humanlike animation of the presenter 202. For example, the animation player 224 performs an algorithm that accordingly adjusts the captured motion, facial, and voice expressions of the presenter 202 based on the contents of the report-script. In this example, the algorithm generates the computer-generated multimedia narrative 112 that is stored in the database 110 (i.e. animation database) as discussed in FIG. 1 above.

In an implementation, a teleconferencing orchestrator 226 is configured to synchronize delivery of the multimedia narrative 112 with any written or oral questions or queries from the one or more users 102. For example, the teleconferencing orchestrator 226 coordinates with a teleconferencing system 228 to deliver the multimedia narrative 112 to user-devices 104. In this example, the teleconferencing orchestrator 226 may receive written or oral questions or queries from the one or more users 102 and communicates to the presenter 202 the received written or oral questions or queries.

For example, the question-answering system 208 is configured to receive the submitted question from the teleconferencing orchestrator 226. In this example, the question-answering system 208 transcribes this question into textual form (if the submitted question is made orally) and aggregate and/or package the submitted questions for presentation to the presenter 202.

With the presented submitted question on hand, the presenter 202 skims question texts and selects which question or questions to answer. For example, the presenter 202 records or writes an answer to each question. In this example, the answer is submitted back to the question-answering system 208, which forwards the same to the teleconferencing orchestrator 226 for delivery to the one or more users 102. The forwarding is implemented through or via animation player 224 such that the animated presenter is perceived to be answering the questions itself and hence indiscernible from the real (human) presenter.

For example, the delivery of the answer may be implemented by the officer 106 who first recites the question and then announces the corresponding answer. In this example, the presenter 202 further saves time and resources with regard to answering questions and queries from the audience such as the one or more users 102.

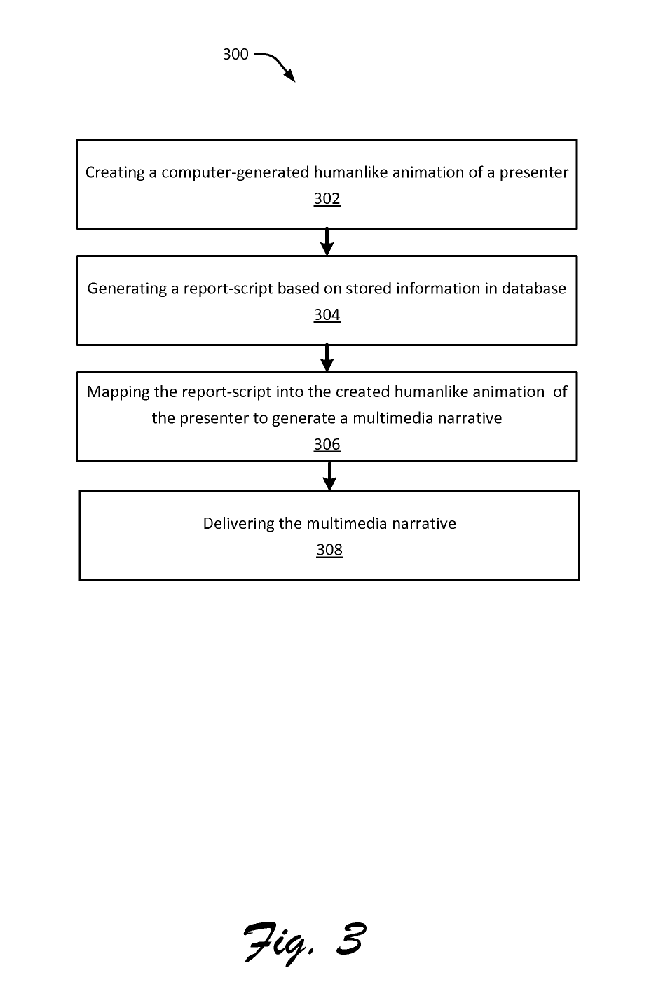

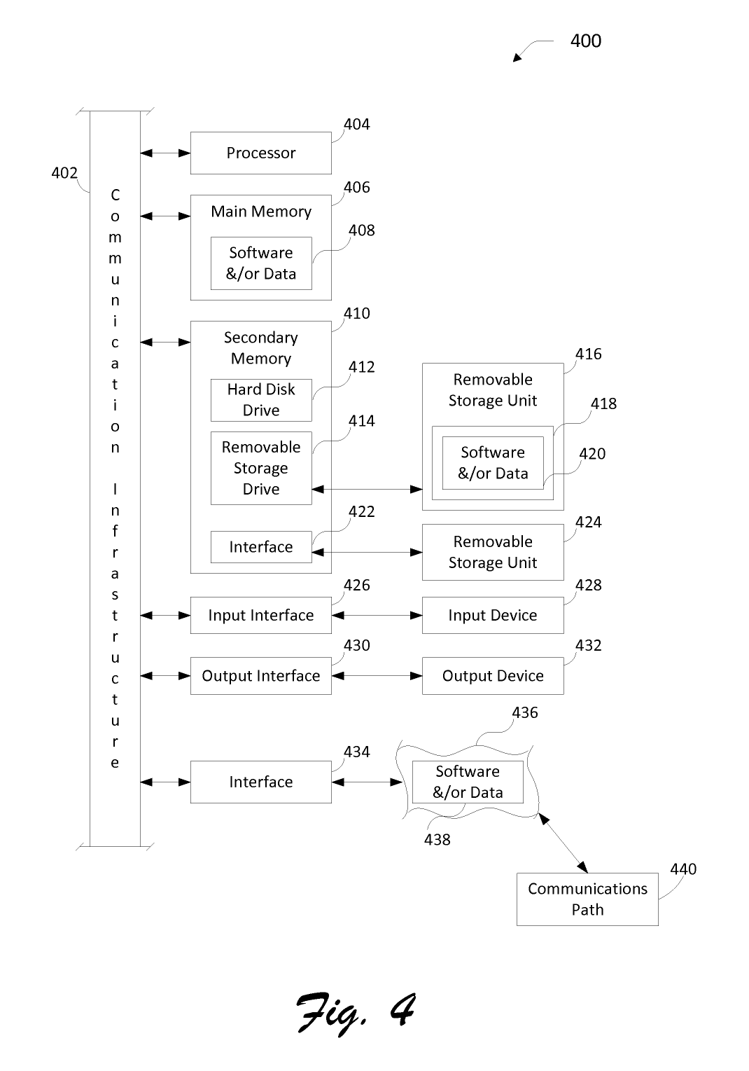

FIG. 3 illustrates an exemplary process 300 for implementing, at least in part, the technology described herein. In particular, process 300 depicts a flow to implement a method of automating multimedia narrative—presentation to one or more user. The process 300 may be performed by a computing device or devices. An exemplary architecture of such a computer device is described below with reference to FIG. 4. In this particular example, the process 300 describes that certain acts are performed at or by a user or a system.

At 302, creating a computer-generated humanlike animation of a presenter is performed. For example, physical characteristics of the presenter 202 are captured and transformed into a computer-generated humanlike animation. In this example, voice synthesis, motion capture, facial mapping, and the like, are digitally copied so that the humanlike animation of the presenter 202 may be configured to perform actions such as singing, dancing, lecturing, etc. as if the presenter himself is doing the actions.

At 304, generating a report-script based on stored information in database is performed. For example, an algorithm is implemented to create narratives or report-scripts out of financial statements and other information or financial reports from the database. In this example, the created narratives or report-scripts are forwarded for approval and revision by the presenter 202. The presenter 202 may insert additional inputs, perform revisions, etc. before approving the recommended narratives or report-scripts.

At 306, mapping the report-script into the created humanlike animation of the presenter to generate a multimedia narrative is performed. For example, the animation player 224 performs an algorithm that accordingly adjusts the captured motion, facial, and voice expressions of the presenter 202 based on the contents of the report-script. In this example, the algorithm generates the computer-generated multimedia narrative 112 that is subsequently stored in the database 110.

Furthermore, the mapping includes transforming the generated report-script from a written script into a speech-script. With the speech-script, the animation player 224 configures the humanlike animation's movements and gestures to correspond to a format or content of the report-script of the speech-script. This configuration is further integrated to the stored multimedia narrative 112 for user's consumption.

At 308, delivering the multimedia narrative is performed. For example, the teleconferencing orchestrator 226, through the teleconferencing system 228, is configured to facilitate the delivery of the conference, seminar, or talk, to the one or more users 102 through the network 108. In this example, the one or more users 102 may submit questions or queries through the teleconferencing orchestrator 226. The questions or queries may be in the form of written or oral queries. The presenter 202 may in real-time answer these questions and queries and the humanlike animation version of the presenter 202 may deliver the answer to the audience.

In another implementation, the delivering of the multimedia narrative 112 includes additional information from the presenter 202 where the additional information may provide responses that were not anticipated (e.g., not in the report-script) when the animation was generated.

FIG. 4 illustrates an exemplary system 400 that may implement, at least in part, the technologies described herein. The computer system 400 includes one or more processors, such as processor 404. Processor 404 can be a special-purpose processor or a general-purpose processor. Processor 404 is connected to a communication infrastructure 402 (for example, a bus or a network). Depending upon the context, the computer system 400 may also be called a client device.

Computer system 400 also includes a main memory 406, preferably Random Access Memory (RAM), containing possibly inter alia computer software and/or data 408.

Computer system 400 may also include a secondary memory 410. Secondary memory 410 may include, for example, a hard disk drive 412, a removable storage drive 414, a memory stick, etc. A removable storage drive 414 may comprise a floppy disk drive, a magnetic tape drive, an optical disk drive, a flash memory, or the like. A removable storage drive 414 reads from and/or writes to a removable storage unit 416 in a well-known manner. A removable storage unit 416 may comprise a floppy disk, a magnetic tape, an optical disk, etc. which is read by and written to by removable storage drive 414. As will be appreciated by persons skilled in the relevant art(s) removable storage unit 416 includes a computer usable storage medium 418 having stored therein possibly inter alia computer software and/or data 420.

In alternative implementations, secondary memory 410 may include other similar means for allowing computer programs or other instructions to be loaded into computer system 400. Such means may include, for example, a removable storage unit 424 and an interface 422. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 424 and interfaces 422 which allow software and data to be transferred from the removable storage unit 424 to computer system 400.

Computer system 400 may also include an input interface 426 and a range of input devices 428 such as, possibly inter alia, a keyboard, a mouse, etc.

Computer system 400 may also include an output interface 430 and a range of output devices 432 such as, possibly inter alia, a display, one or more speakers, etc.

Computer system 400 may also include a communications interface 434. Communications interface 434 allows software and/or data 438 to be transferred between computer system 400 and external devices. Communications interface 434 may include a modem, a network interface (such as an Ethernet card), a communications port, a Personal Computer Memory Card International Association (PCMCIA) slot and card, or the like. Software and/or data 438 transferred via communications interface 434 are in the form of signals 436 which may be electronic, electromagnetic, optical, or other signals capable of being received by communications 434. These signals 436 are provided to communications interface 434 via a communications path 440. Communications path 440 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 416, removable storage unit 424, and a hard disk installed in hard disk drive 412. Computer program medium and computer usable medium can also refer to memories, such as main memory 406 and secondary memory 410, which can be memory semiconductors (e.g. Dynamic Random Access Memory (DRAM) elements, etc.). These computer program products are means for providing software to computer system 400.

Computer programs (also called computer control logic) are stored in main memory 406 and/or secondary memory 410. Such computer programs, when executed, enable computer system 400 to implement the present technology described herein. In particular, the computer programs, when executed, enable processor 404 to implement the processes of aspects of the above. Accordingly, such computer programs represent controllers of the computer system 400. Where the technology described herein is implemented, at least in part, using software, the software may be stored in a computer program product and loaded into computer system 400 using removable storage drive 414, interface 422, hard disk drive 412 or communications interface 434.

The technology described herein may be implemented as computer program products comprising software stored on any computer useable medium. Such software, when executed in one or more data processing devices, causes data processing device(s) to operate as described herein. Exemplary illustrations of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more exemplary implementations described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

What is claimed is:

1. A method of implementing an automated multimedia narrative—presentation to one or more users, the method comprising:
creating a computer-generated animation of a presenter;
generating a report-script based on stored information in a database;
mapping the report-script into the created animation of the presenter to generate a multimedia narrative; and
delivering the multimedia narrative to the one or more users.

2. The method according to claim 1, wherein the creating of the animation comprises synthesizing and adapting captured facial, voice, and motion expressions of the presenter.

3. The method according to claim 1, wherein the generating comprises performing an algorithm on the stored information that comprises financial statements and financial reports.

4. The method according to claim 1, wherein the generating of the report-script comprises receiving a presenter-approved version of the report-script.

5. The method according to claim 4, wherein the presenter-approved version comprises presenter-revisions of the algorithm-generated report-script.

6. The method according to claim 1, wherein the mapping comprises configuring the animation's movements and gestures to correspond to a format or content of the report-script.

7. The method according to claim 1, wherein the delivering of the multimedia narrative comprises receiving oral or written questions or queries from the one or more users.

8. The method according to claim 7, wherein answers by the presenter to the oral or written questions or queries are mapped to the created animation of the presenter.

9. The method according to claim 7, wherein the delivering the multimedia narrative comprises additional information from the presenter, the additional information provides responses that were not anticipated when the animation was generated.

10. A device comprising:
an animation generator configured to create a computer-generated animation of a presenter;
a script-generator configured to generate a report-script based on stored information in a database;
an animation player configured to map the report-script into the created animation of the presenter to generate a multimedia narrative; and
a teleconferencing orchestrator configured to facilitate delivery of the multimedia narrative to one or more users.

11. The device according to claim 10, wherein the animation generator further comprising a motion capture engine, a facial capture engine, and a voice sampling engine, to capture and synthesize motion, facial, and voice expressions, respectively, of the presenter.

12. The device according to claim 10, wherein the script-generator performs an algorithm on the stored information to generate the report-script, wherein the stored information comprises financial statements and financial reports.

13. The device according to claim 12, wherein a presenter-approved version of the report-script comprises presenter-revisions of the generated report-script.

14. The device according to claim 10, wherein the mapping by the animation player comprises configuring the animation's movements and gestures to correspond to a format or content of the report-script.

15. The device according to claim 10 further comprising a question-answering system configured to relay answers to questions or queries by the one or more users, wherein the answers are relayed via the animation player.

16. One or more non-transitory computer-readable media storing processor-executable instructions that when executed cause one or more processors to perform operations comprising:
creating an animation by capturing and synthesizing motion, facial, and voice expressions of a presenter;
generating a report-script based on an information in a database;
mapping the report-script into the created animation of the presenter to generate a multimedia narrative; and
delivering the multimedia narrative to one or more users.

17. The one or more computer-readable media according to claim 16, wherein the generating of the report-script comprises receiving a presenter-approved version of the report-script.

18. The one or more computer-readable media according to claim 17, wherein the presenter-approved version comprises presenter-revisions of the generated report script.

19. The one or more computer-readable media according to claim 16, wherein the mapping comprises configuring the animation's movements and gestures to correspond to a format or content of the report-script.

20. The one or more computer-readable media according to claim 16, wherein the delivering of the multimedia narrative comprises receiving of oral or written questions or queries from the one or more users.
